(19) United States
(12) Patent Application Publication
(10) Pub. No.: US 2014/0125438 A1
(43) Pub. Date: May 8, 2014

(54) EXCITED FERRO ELECTRO DYNAMO

(71) Applicant: Nathan Senthilvel Ambalam, Tamil Nadu (IN)

(72) Inventor: Nathan Senthilvel Ambalam, Tamil Nadu (IN)

(21) Appl. No.: 14/128,117

(22) PCT Filed: Jun. 12, 2012
(86) PCT No.: PCT/IN2012/000415

§ 371 Date: Dec. 20, 2013

(30) Foreign Application Priority Data
Jun. 30, 2011 (IN) 2235/CHE/2011

(51) Int. Cl. H02K 99/00

(52) U.S. Cl. CPC H02K 57/006; H02N 11/008
USPC 335/306; 74/DIG. 9

(57) ABSTRACT

Excited ferro electro dynamo is a green energy invention that generates a ferro electro mechanical energy. This energy is the outcome of the angular momentum of the rotor, a permanent magnet, along the excited helical magnetic force S (FIG. 1/1) of the stator. The stator consisting of permanent magnets and ferrous metals arranged in a triangular fashion generates a helicity of magnetic force in order to drive the rotor, in one and the same direction. In this type of arrangement, the poles N,S,N (FIG. 1/1) of permanent magnets with ferrous metals form triangles and parallelograms, where the excitation of the magnetic force remains constant.

### FIELD OF THE INVENTION

The present invention relates to energy generation in general and ferro electro mechanical energy in particular. For which the unique properties of permanent magnets are utilized. Existing permanent magnet machines invariably are in need of external energy sources to perform. But the present invention Excited ferro electro dynamo needs no external energy sources, but its own constituent magnetic force. The magnetic force has been directly utilized to move a rotor of permanent magnet against a stator of permanent magnets, thereby paving a way for generating a mechanical energy. This is termed as ferro electro mechanical energy, because, as ferromagnetism retains magnetism even in the absence of its source, electricity, there must be a substance to retain electricity, even in the absence of the same. Hence, the term ferro electricity is widely given to such phenomenon that exhibits electrical conductivity in the absence of live electrical source in the conventional sense. So this invention belongs to that category.

The present invention Excited ferro electro dynamo, a green technology that generates a ferro electro mechanical energy constantly from permanent magnets and ferrous metals that are arranged in an excited specific sequence of charge: neutral—a sequence of two up charge and one down charge with one up neutral with two down neutral, following micro cosmic principles.

### BACKGROUND OF THE INVENTION

Of all the substances available as of now, a substance that has got a force is none other than a permanent magnet. So magnets are very much preferred to extract energy from them rather than from any other materials. Many devices have been proposed to extract energy from permanent magnets so far. Most of those prior arts are based on this ferro electro mechanism.

One such prior art for a ferro electro device numbered WO2007148146 is about extracting energy from permanent magnets. What was claimed in this closely related prior art “Turbo and Dynamo Utilising Hyperconductivity of Ferro Electro Mechanism” was the method of construction of a ferro electro mechanical device that should run on its own internal energy, without consuming any input from any external energy sources. But the mechanism had drawbacks on many counts such as stiff resistance, as it was built to work on its own force where sufficient attention was not paid to address the resistance factor. In this prior art, though the ways of extracting energy from permanent magnets are discussed, it has its inherent drawbacks. The resistance inherent to any magnetic material has not been fully addressed.

Another prior art numbered WO2010070674 for “System employing magnetic effect for energy generation and its operating method” is also about generation of energy from permanent magnets. In this prior art, though the resistance has been addressed the drag that is inherent to all permanent magnet machines is not addressed.

So, in order to be free from resistance and drag for an all magnetic device to generate energy, a novel method is needed with improvements over the above cited prior arts. One such proposed device is the present invention Excited ferro electro dynamo.

The present invention is substantially magnets in triangles with steps which generates a magnetic helical sort of force. These magnetic triangles with steps are eventually incorporated into an all-magnet machine Excited ferro electro dynamo, the proposed one. The present invention in triangular dimension has an emphatic edge, with a helical magnetic field force, over the related prior arts that are to run under huge resistance and drag.

The objective of the present invention Excited Ferro Electro Dynamo is to run the device on its own constituent materials, iron mix permanent magnets. Another objective is to provide a simple energy generating device.

The present invention categorically uses hyperfine charge, a generated helicity of magnetic force, to drive the rotor, as described in the specification and pointed out in claims. Hence, the present invention is an improved version over the related prior arts that are cited above.

The present invention Excited ferro electro dynamo is a green energy device. This ferro electro mechanical energy is derived from moving the rotor over and around the stator consisting of permanent magnets and ferrous metals without using any fuels.

### SUMMARY OF THE INVENTION

The machines that are widely in use can not run on their own for they are in need of external energy sources. Whereas the present invention Excited ferro electro dynamo, there is an in built mechanism that sustains the rotation of the rotor to which a shaft is connected in order to utilize the rotation in our day to day activities. Thus energy crisis can be solved considerably.

The uniqueness of this invention is that both the stator and the rotor in it are permanent magnets. No electricity is fed into it, as it performs on a ferro electro mechanism. In fact, electricity can be generated by coupling a dynamo to this invention. Once constructed it starts running and keeps running till the magnetism in the machine lasts. How long it will be going on like this can not be ascertained as it is very difficult to determine the longevity of a permanent magnet with high coercive force.

The present invention Excited ferro electro dynamo, a green technology, generates a ferro electro mechanical energy from iron mix magnets conforming to the working principles of a cosmological constant—an excited specific sequence of magnetic charge: ferrous neutral—on the scale of micro cosmic elementary particles that assures an energetic solution to the present day energy crisis.

It is everyday knowledge that a permanent magnet is a unique material that has got force. So, magnets are very much preferred for the unique property, to extract energy from them rather than from any other materials. So, many devices have been proposed to extract energy only from permanent magnets.

The prior arts of all-magnet machines are more known for their drawbacks such as resistance and drag rather than their efficacy.

So, in order to be free from resistance and drag for an all magnetic device to generate energy, a novel method is needed with improvements over the prior arts. One such proposed device is the present invention Excited ferro electro dynamo. The preferred embodiment of the present invention can be described as follows.

The stator of this Excited ferro electro dynamo consists of permanent magnets and ferrous metals arranged in a specific sequence in a triangular fashion, so that it generates a helicity of magnetic force in order to drive the rotor in one and the same direction. In this type of arrangement of permanent magnets with ferrous metals in triangles, the excitation of the magnetic force remains constant in the form of helicity of magnetic force.

To realize a helicity of magnetic force, Permanent magnets are shaped into a triangle to build this invention. Ferrous metals are also arranged into a triangle in order to conjoin it with the triangular permanent magnets. For this to take shape, three permanent magnets are taken and arranged into a triangle. Forming triangular permanent magnets and ferrous metals is the first step to perform this invention Excited ferro electro Dynamo. When one set of this triangular permanent magnets and ferrous metals is arranged side by side in an up and down fashion they form a parallelogram. One more set of this triangular permanent magnets and ferrous metals is arranged side by side in an up and down fashion to form another parallelogram. And these two parallelograms should be joined together in order to bring about a ferro electric shape Z. Now this arrangement has the S, south pole facing upward. One more arrangement should be made with N, north pole facing upward.

This duo ferro electric shapes of permanent magnets and ferrous metals of parallelograms arranged with triangular permanent magnets and triangular ferrous metals is to be brought about with N, north pole facing upward and placed over the first one creating steps, so that S south pole of the first one and the second one face each other in the middle, while N and N of these two ferro electrically shaped iron mix magnets are up and down at the far ends create a helicity of sorts of magnetic force at a considerable distance, well away from the stator assembly.

Hence, the alternated permanent magnets and ferromagnetics arranged in a ferro electro fashion with steps that has positively charged north poles and negatively charged south poles in the above N,S,N, display substantially the characteristics a magnetic helicity S in an excited state.

The rotor, a permanent magnet circumambulates the stator over this helical of sort magnetic force, and then over stator assembly itself. The forces that are above the stator assembly are both towards and against the spinning direction of the rotor. So both the forces get cancelled over there, at the stator. The balance of thrust is the helical force around the stator. And the rotor takes this route.

This Excited ferro electro dynamo is a green tech invention that generates a ferro electro mechanical energy. This energy is the outcome of a permanent magnet rotor that goes on moving under the impact of the helical magnetic force of the stator.

The Utility point of view of this invention is that the application area of this invention is far and wide, where source (of fuel) for electricity generation is scarce. It is very simple to construct with permanent magnets and iron plates with reduced capital cost. This machine does not depend upon any external energy sources such as electricity, fuel etc. It runs on its own energy. In our machine the magnetic force gets transformed in to mechanical energy. Once started it runs for years together. So there is nil operating cost.

It is light weight. So easy to handle and carry. When rare earth magnets which are small in size and powerful in performance with high coercive force are used in our machine, it is as good as any machine as volume wise. Our machine does not need any fuel; non stop function is assured of this invention. It is Very reliable one with permanent magnets and ferrous metals. No other components are fixed. It is known for its robustness. It is safer to handle. As for as lay out and serviceability is concerned. No complicated workmanship is required to service this machine as it contains fewer components. The advantages of this dynamo are far more than those cited above. This dynamo is an eco clean device!

### DETAILED DESCRIPTION OF THE INVENTION

Magnetic helicity might be an elusive entity in nature; but the same can be realized by arranging a cluster of permanent magnets and ferromagnetics, in such a manner that the resultant magnetic force should exhibit the characteristics of a helical magnetic force, a focused beam of magnetic force at tangent, as against the divergent lines of force observed in all dipolar magnetism.

To achieve this helicity, a triangular arrangement of iron mix magnets is effected in this invention, true to its sort it belongs to: this being a ferro electro mechanical system a ferro electric shape is given to the permanent magnets and ferromagnetics. A focused magnetic force that jets out from this arrangement incorporated in a stator is all set to drive the rotor magnet in one and the same direction. It has a helical magnetic force that strives hard to drive the rotor magnet. The present invention has a focused helical magnetic force with a triangular arrangement of iron mix magnets in the stator that drives the rotor magnet with ease.

The focussed beam of magnetic force at any given tangent point that emerges from the infinite cluster of iron mix magnets, which is in a state of charged helicity, displaces another permanent magnet in one direction only and not in both the directions as in the case of a dipole magnet due to nil charge. The movement of the magnet in both the directions shows that the charge gets cancelled in the case of dipolar magnetism; or rather the 0 charge does not effect a unidirectional movement of another magnet. But in the present invention, apart from neutralization there is one more force is created, a helical force out of usual spherical force, which is but normal in all magnetic materials. The new magnetic force helix is a longitudinal polarization that remains in an excited state.

The preferred embodiment of the present invention Excited ferro electro dynamo can be best understood as disclosed here:

In the stator permanent magnets are shaped into a triangle to build this invention. Ferrous metals are also arranged into a triangle in order to conjoin it with the triangular permanent magnets. For this to take shape three permanent magnets are taken and arranged into a triangle. Forming triangular permanent magnets and ferrous metals is the first step to perform this invention Excited ferro electro Dynamo. At first one set of this triangular permanent magnets and ferrous metals are arranged side by side in an up and down fashion they form a parallelogram. One more set of this triangular permanent magnets and ferrous metals are arranged side by side in an up and down fashion they form another parallelogram. And these two parallelograms should be joined together in order to bring about a ferro electric shape, a sort of Z. Now this arrangement has the S, south pole facing upward. Change in polarity is admissible as and when change of direction of the rotor is required.

One more ferro electric shape of permanent magnets and ferrous metals of parallelograms arranged in the same manner as described above with triangular permanent magnets and triangular ferrous metals is to be brought about with S, south pole facing upward and placed over the first one so that S south pole of the first one and the second one face each other in the middle, while N and N of these two ferro electrically shaped iron mix magnets are facing up and down at the far ends of this cluster.

This sequence of arrangement of magnetic poles, N,S,N (or SNS) in fact, is capable of driving any permanent magnet rotor due to the helical magnetic force it forms, when incorporated into any permanent magnet motion machine. Hence, the claims are particularly directed to protect this arrangement of permanent magnets and ferrous metals that generates an excited helical magnetic force and the helicity factor of this invention. The focused helical magnetic force jetting out from this system drives the rotor magnet with a shaft that is secured by a strong frame structure to the stator assembly to utilize the ferro electro mechanical energy.

The characteristics of this helical magnetic force testify to the fact that the lines of magnetic force emerge from it are not divergent, but strongly focused, which is capable of moving another permanent magnet in one direction only—a clear demonstration of its prowess as a charged magnetic helicity. Once an asymmetric or rather hypersymmetric arrangement of permanent magnets and ferrous metals are in place thereby effecting a magnetic tri-pole, N,S,N with a trident of magnetic force that encompasses this focused helical magnetic force, the claimed arrangement of magnets, is capable of discharging (displacing) another permanent magnet repeatedly. Electricity can be generated along the path of the rotor from a dynamo device or by coupling a dynamo to this invention by conventional means.

Hence, the alternated permanent magnets and ferromagnetics, following cosmological specific charge neutral ratio are arranged in a three dimensional triangles with steps, displays a force that has substantially the characteristics a magnetic helicity.

The rotor, a permanent magnet circumambulates the stator over a helical of sort magnetic force, and then over stator assembly itself. The forces that are at the stator assembly are of two phases—both towards and against the spinning direction of the rotor. So both the forces get cancelled at the stator! The balance of thrust—one phase is the helical force around the stator.

The present invention categorically uses a helical force, a generated input to drive the rotor, as described in the specification and pointed out in claims. Hence, the present invention, utilizes the hyperfine charge spin ½ that is extracted from the outer region of the circuitous route of the rotor magnet. Since the outer region has 1 unit of portion of magnetic helicity and the neutral zone of the stator has the 2 units of force, the extracted charge for the rotor, spin ½ is considered to be convincingly an input from the extended energy source, a cluster of permanent magnets.

The above and other features of the present invention including the various novel details of the construction and combination of magnetic parts will now be more particularly described.

To start with three numbers of permanent magnets, two up and one down are arranged into a triangle; then three numbers of ferrous metals, one up and two down, in the stator. Many more triangular dimensional structures are to be added in the stator, in multiples of six (six fold), to get, at the most, a two numbers of three dimensional ferro electro shape to achieve a tangible alteration in the nature of magnetic force, to move the rotor magnet; that addresses the inherent stiff resistance in the stator.

In the present invention, three numbers of permanent magnets and an equal, three, numbers of ferromagnetics are employed; but they are spread out into a triangle, and then a parallelogram, at the very outset itself—a novelty. Every other addition would be nothing but triangles of permanent magnets and ferromagnetics. An alteration in the magnetic property is significantly achieved. Energetic sequence of ironmix magnets settles down, once and for all, with one set of ferromagnetics and permanent magnets in ferro electric shapes in order to maintain its dynamic prowess, a focused helical magnetic force.

The present invention has one more novel feature, in that the lines of force, originating from the poles of triangular magnet and then the parallelogram magnet constructed in conjunction with ferromagnetic materials, remain converged and focused in the middle of this helicity to drive the rotor, a permanent magnet, without resistance. The drag is completely eliminated. A spin ½ is achieved by this arrangement of ironmix magnets. The arrangement of permanent magnets and ferrous metals is substantially triangle with steps that generates a magnetic input to any all magnet machines to run it as in the present invention.

As there is an incongruous arrangement of magnetic poles in each ferro electro shaped assembly, a pole-wise parity violation is obvious, and force-wise a broken symmetry is apparent in this helical hyper symmetric power magnetics where a fusion of magnetic elements takes place in conjunction with ferrous metals, only to maximize the utility of this novel green energy invention ferro dynamo for the comforts in life at large.

Thus, initially a ferro electro mechanical energy is generated, upon which generation of electric energy is a possible prime option, a clean technology, on the whole!

The double ferro electro arrangement with a fusion of magnetic force in the middle, as the like poles face each other—a kind of yoking system—squeezes out the magnetic force into a helicity magnetic force away and around the stator assembly that drives the rotor, another permanent magnet, which at first generates a ferro electro mechanical energy and then in turn engages a dynamo device too to generate current electricity.

Permanent magnets and ferrous metals are arranged into a helical symmetry by following a cosmological charge—neutral sequence. The ferro electrically configured triangles, true to the equation depict a picture of Z wherein neutro-iron is squired in relation to magnets and iron pieces and again magnet is squired. Hence helicity, Hy=I² M I M², where ‘I’ stands for neutro-iron and M′ for magnetic charge in the stator of this, ferro electro engine that depicts and a unification of force, a focused helical force.

Cosmology and its working principles are incorporated in this invention in such a way that it has two charged magnetic poles and one neutro iron at the top line, and one charged magnetic pole and two neutro iron at the bottom line that form all the parallelograms.

The all-magnet machines that are re-energized with this input can be coupled to all the rotary engines to economize the running cost, apart from utilizing them as independent rotary device, either to generate electricity or for other useful purposes, with an assured continuous angular momentum of the rotor.

By fixing the rotor assembly exactly over the segment of that arranged iron mix magnet array, pole-wise a double helix, so that a maximum force from unlike poles are covered, where the focusing helical force is strong, leaving the weak force from the path of the rotor out, with certainty the torrential helical force can be utilized from the power generation unit, that is housed compactly in the stator assembly of this ferro electro engine.

The efficacy point of view of the present invention is that it can even be utilised as a stand alone system that generates an input and supply it to any all-magnet machine which would be pressed into service in all activities of human life or as an augmentation for any engine, be it rotary or reciprocatory one, which would economize the running cost, on land, sea, in air and beyond.

The above and other features of the invention including the various novel details of the construction and combination of parts will be more particularly described and ascertained with reference the accompanying drawings and pointed out in the claims. It will be understood that the particular dynamo construction embodying the invention is shown by way of illustration only and not as a limitation of the invention. The principles, concepts and features of this invention may be employed in various and numerous applications and embodiments without departing from the scope of this invention.

The present invention Excited ferro electro dynamo works on the constant excitation of magnetic force field. This excitation is possible due to the novel arrangement of permanent magnets with ferrous metals in the specific sequence. In this type of arrangement the permanent magnets act as charged particles and the ferrous metals act as neutral ones on a cosmological scale. Thus helicity of magnetic force is created out of the usual spherical magnetic force from permanent magnets and ferrous metals that are arranged in the above described manner. Hence, helicity, Hy=I² M I M².

A green technology right from ferro electro mechanical energy generation and electric energy generation unto its end use, this engine constructed on hypersymmetric powermagnetics as shown in the drawing, is to cater to the rising energy needs of all sectors through industrialization.

In the accompanying drawings wherein an illustrative embodiment of the invention is shown from which its novel features of magnetic parts and advantages will be apparent.

### DESCRIPTION OF THE DRAWINGS

The above and other features of the invention including the various novel details of the construction and combination of parts of iron mix magnets will now be more particularly described with reference the accompanying drawings and pointed out in the claims.

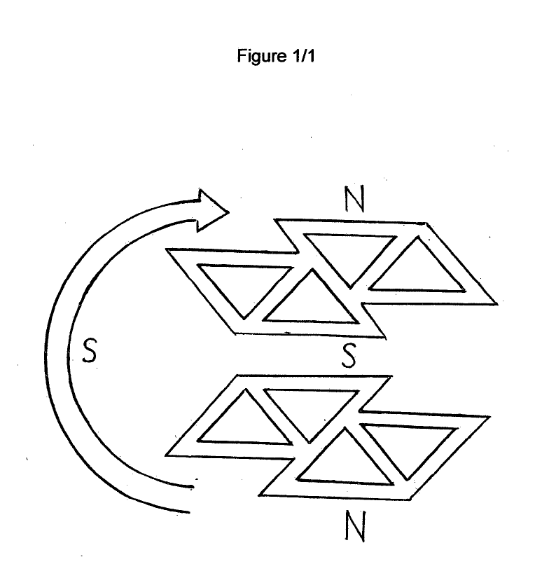

The drawing, FIG. 1/1 shows the preferred embodiment of the present invention Excited ferro electro Dynamo. As shown in the drawing a triangular dimension in the stator comprises three numbers of permanent magnets and an equal, three, numbers of ferromagnetics, six in all, are arranged into triangles. Many more triangular dimensional structures are added in the stator, in multiples of triplets, to get, at the most, a two numbers of three dimensional ferro electro shapes to achieve a tangible alteration in the nature of magnetic force, to move the rotor magnet; that addresses the inherent stiff resistance and the drag in the stator.

In the present invention, three numbers of permanent magnets and an equal, three, numbers of ferromagnetics are employed; but they are spread out into a triangles as shown in the drawing at the very outset itself—a novelty; every other addition would be nothing but triangles of permanent magnets and ferromagnetics as shown in the drawing. Thus an alteration in the magnetic property—a helicity of magnetic force is significantly achieved.

The above sequence settles down, once and for all, with two sets of ferro electro shapes of ferromagnetics and permanent magnets in order to maintain its dynamic prowess, a focused magnetic force with helicity factor. The present invention has one more novel feature, in that the lines of force, originating from the poles of triangular permanent magnets constructed in conjunction with ferromagnetic materials, remain converged and focused in the middle and spread out rather squeezed out as helicity or in other words describes a helical motion of the magnetic force. Thus a longitudinal polarization is realized around the stator.

To be precise the helical magnetic force is a hyperfine charge 1 unit, which is utilized from the outer region of the circuitous route of the rotor magnet. Since the outer region has an active moving zone for the rotor against the neutral zone—1 unit for and 1 unit against the rotor's spinning direction at the stator, the extracted charge +½ is convincingly a spin ½ available from the extended source of a cluster of permanent magnets of the stator.

As shown in the drawing (FIG. 1/1) permanent magnets are shaped into a triangle to build this invention. Ferrous metals are also arranged into a triangle in order to conjoin it with the triangular permanent magnets. For this to take shape three permanent magnets are taken and arranged into a triangle. Forming triangular permanent magnets and ferrous metals is the first step to perform this invention Excited ferro electro Dynamo.

When one set of this triangular permanent magnets and ferrous metals are arranged side by side in an up and down fashion they form a parallelogram. One more set of this triangular permanent magnets and ferrous metals are arranged side by side in the same up and down fashion as described they form another parallelogram. And these two parallelograms should be joined together in order to bring about a ferro electric shape Z as shown in the drawing. Now this arrangement has the S, south pole facing upward.

Another ferro electric shape of permanent magnets and ferrous metals of parallelograms arranged in the same manner as described above with triangular permanent magnets and triangular ferrous metals is to be brought about with S, south pole facing upward and placed over the first one so that S south poles of the first and the second one face each other in the middle, while these two ferro electrically shaped iron mix magnets with N north poles up and down with steps are positioned (FIG. 1/1).

The above stepping assembly of the twin ferro electro configuration of permanent magnets and ferrous metals get fused together. The rotor magnet moves along the helicity of magnetic force shown with an arrow S (FIG. 1/1) that shows the moving direction of the rotor.

As shown in the drawing a pole-wise parity violation is obvious, as there is an incongruous arrangement of magnetic poles in each ferro electro shaped fixed member and force-wise a broken symmetry is apparent in this helical hyper symmetric power magnetics where a fusion of magnetic elements takes place in conjunction with ferrous metals, that shows as N,S,N, where S is sandwiched between top N and bottom N only to create a helical force to carry the rotor magnet along with it.

1. Excited ferro electro dynamo consisting of a cluster of permanent magnets and ferrous metals where three numbers of permanents and three numbers of ferrous metals are arranged in an up and down fashion side by side to get the magnetic force excited in this triangular arrangement and the same arrangement is repeated many times and closely placed together to bring about a helicity of magnetism in the stator in order to drive the rotor, a permanent magnet, along the helicity of magnetic field force.

2. Excited ferro electro dynamo as claimed in claim 1, wherein the said permanent magnets and the ferrous metals initially form triangles and then parallelograms in order that they finally form a set of ferro electro configuration Z.

3. Excited ferro electro dynamo as claimed in claim 1, wherein the said permanent magnets and the ferrous metals form the said triangles, parallelograms and ferro electro shapes in steps.

4. Excited ferro electro dynamo as claimed in claim 1, wherein the said permanent magnets and the ferrous metals so arranged in steps, that the like poles of the permanent magnets in each arrangement face each other in the middle.

5. Excited ferro electro dynamo as claimed in claim 1, wherein the said permanent magnets and the ferrous metals in the stator display a helical magnetic force in order to drive another permanent magnet, the rotor.

6. Excited ferro electro dynamo as claimed in claim 1, wherein the said permanent magnets and the ferrous metals in the stator form three phases of magnetic force—two units of force towards the spinning direction of the rotor, and one against it.

7. Excited ferro electro dynamo as claimed in claim 6, wherein the said permanent magnets and the ferrous metals in the stator create a spin ½ situation to drive the said rotor.

8. Excited ferro electro dynamo as claimed in claim 6, wherein the said rotor moves in the same direction due to the net gain of 1 out of 3 unit of magnetic force of the stator.

9. Excited ferro electro dynamo as claimed in claim 6, wherein the magnetic force helix is a longitudinal polarization that runs excited around the stator to drive the rotor.

10. Excited ferro electro dynamo as claimed in claim 6, wherein the helicity of magnetic field forces the permanent magnet rotor, thereby generating a ferro electro mechanical energy.
